(19) United States
(12) Patent Application Publication
(10) Pub. No.: US 2025/0301518 A1
(43) Pub. Date: Sep. 25, 2025

(54) INTER-NODE COMMUNICATION FRAMEWORK FOR COORDINATED WIRELESS NODE MECHANISMS

(71) Applicant: QUALCOMM Incorporated, San Diego, CA (US)

(72) Inventors: Gaurang NAIK, San Diego, CA (US); Abhishek Pramod PATIL, San Diego, CA (US); George CHERIAN, San Diego, CA (US); Giovanni CHISCI, San Diego, CA (US); Sanket Sanjay KALAMKAR, San Diego, CA (US); Sherief HELWA, San Diego, CA (US); Alfred ASTERJADHI, San Diego, CA (US); Sai Yiu Duncan HO, San Diego, CA (US)

(21) Appl. No.: 19/084,558

(22) Filed: Mar. 19, 2025

Related U.S. Application Data
(60) Provisional application No. 63/567,895, filed on Mar. 20, 2024.

(51) Int. Cl. H04W 76/14; H04W 72/0446; H04W 76/15; H04W 84/12

(52) U.S. Cl. CPC H04W 76/14; H04W 72/0446; H04W 76/15; H04W 84/12

(57) ABSTRACT

Certain aspects of the present disclosure provides a method for wireless communication performable at a first wireless node (e.g., a first access point (AP)). The method may involve establishing a session with a second wireless node (e.g., a second AP) by exchanging information with the second wireless node regarding one or more features of a coordinated communication scheme supported by the first wireless node and the second wireless node.

### CROSS-REFERENCE TO RELATED APPLICATION

This application claims the benefit of and priority to U.S. Provisional Application No. 63/567,895, filed Mar. 20, 2024, which is assigned to the assignee hereof and hereby expressly incorporated by reference in its entirety as if fully set forth below and for all applicable purposes.

### TECHNICAL FIELD

This disclosure relates generally to wireless communication, and more specifically, to coordinated mechanisms.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

One aspect provides a method for wireless communication at a first wireless node. The method includes obtaining a first frame indicating that a second wireless node is capable of supporting a coordinated communication scheme, wherein the first wireless node is associated with a first basic service set (BSS) and the second wireless node is associated with a second BSS; establishing a session with the second wireless node by exchanging information with the second wireless node regarding one or more features of the coordinated communication scheme supported by the first wireless node and the second wireless node; and participating in the session using the coordinated communication scheme, said participation being based on one or more parameters associated with the exchange of information.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

FIG. 1 shows a pictorial diagram of an example wireless communication network.

FIG. 2 and FIG. 3 show example protocol data units (PDU) usable for communications between a wireless access point (AP) and one or more wireless stations (STAs).

FIG. 4 shows a hierarchical format of an example physical layer PDU (PPDU) usable for communications between a wireless AP and one or more wireless STAs.

FIG. 5 shows a block diagram of an example multi-link device (MLD) deployment.

FIG. 6 shows an example state diagram for a coordinated AP (CAP) session, which may also be referred to as a Multi-AP coordination (MAPC) session.

FIG. 7 shows an example call flow diagram for establishing an MAPC session, in accordance with aspects of the present disclosure.

FIG. 8 shows an example frame format for exchanging information for features of an MAPC scheme, in accordance with aspects of the present disclosure.

FIG. 9 shows example frames for exchanging information for features of an MAPC scheme, in accordance with aspects of the present disclosure.

FIG. 10 shows example frames for exchanging information for features of an MAPC scheme, in accordance with aspects of the present disclosure.

FIG. 11 shows an example frame format for exchanging information for features of an MAPC scheme, in accordance with aspects of the present disclosure.

FIG. 12 shows an example frame format for exchanging information for features of an MAPC scheme, in accordance with aspects of the present disclosure.

FIG. 13 shows a flowchart illustrating an example process performable by a wireless node, in accordance with aspects of the present disclosure.

FIG. 14 shows a block diagram of an example wireless communication device, in accordance with aspects of the present disclosure.

Like reference numbers and designations in the various drawings indicate like elements.

### DETAILED DESCRIPTION

Certain mechanisms may be applicable to communications between wireless nodes, such as between access point (AP) and non-AP stations (STAs), between APs, and/or between non-AP STAs.

For example, ultra-high reliability (UHR)/Wi-Fi 8 may introduce certain Multi-AP coordination (MAPC), which may also referred to as Coordinated AP (CAP) mechanisms, where multiple APs may coordinate to enhance communications in some manner. CAP and MAPC may be used interchangeably. Such mechanisms, for example, may allow two or more APs to coordinate their resources in various ways in order to achieve or improve on a sharing of resources.

For example, coordinated time division multiple access (C-TDMA) may be used to coordinate resources in the time domain, coordinated spatial reuse (C-SR) may be used to coordinate resources in the spatial domain, and coordinate listen intervals (CLI) may be used to coordinate access to the wireless medium. In this context, CLI may include coordinated service periods (SPs), such as coordinated target wakeup time (C-TWT), coordinated restricted target wakeup time (C-RTWT), Inter-AP Coordination Intervals/Epochs, Inter-AP Intervals/Epochs, and AP coordination Intervals/Epochs. Similarly, coordinated beamforming (C-BF), and/or coordinated preemption (C-Preemption) may be used to coordinate preemption among neighboring (such as friendly) APs. Moreover, two or more APs may be a part of a multi-link device (MLD) (e.g., a single mobility domain (SMD) MLD or similar central entity) and may offer seamless roaming functionality to associated clients (such as non-AP STAs).

These schemes may involve APs exchanging information with each other. Such communications may occur over the backhaul, thus, not involving an (802.11) air interface. However, for various reasons (e.g., if inter-vendor interoperability is desirable), aspects of the present disclosure provide a framework for over-the-air (OTA) communication between APs. UHR may benefit from such a framework for APs to communicate with each other (e.g., to exchange information to enable/enhance various MAPC features).

Aspects of the present disclosure provide techniques and mechanisms that may form a framework for inter-AP communications for MAPC sessions. These techniques and mechanisms may be applied to any coordination feature including (but not limited to) C-TDMA, C-SR, CLI, C-BF, and/or C-Preemption. As a result, the techniques provided herein may improve resource utilization, and overall user experience.

### Example Wireless Communication Network

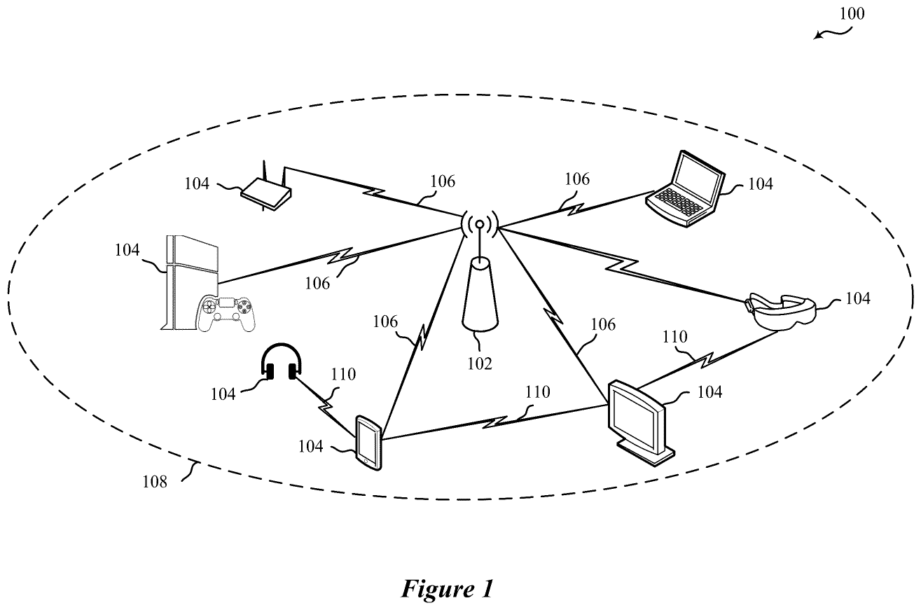

FIG. 1 shows a pictorial diagram of an example wireless communication network 100. The wireless communication network 100 includes various wireless nodes (such as AP STAs and non-AP STAs). According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11bc, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (CNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

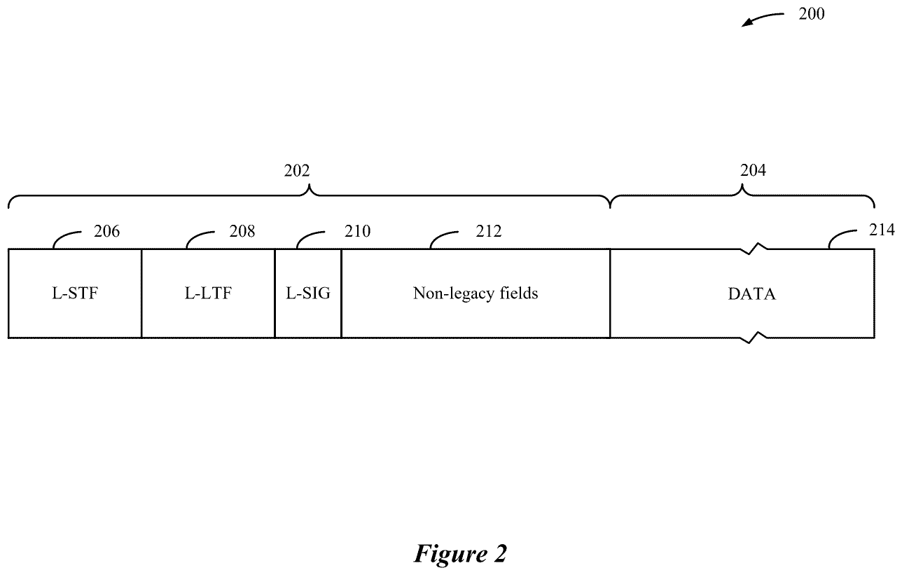

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

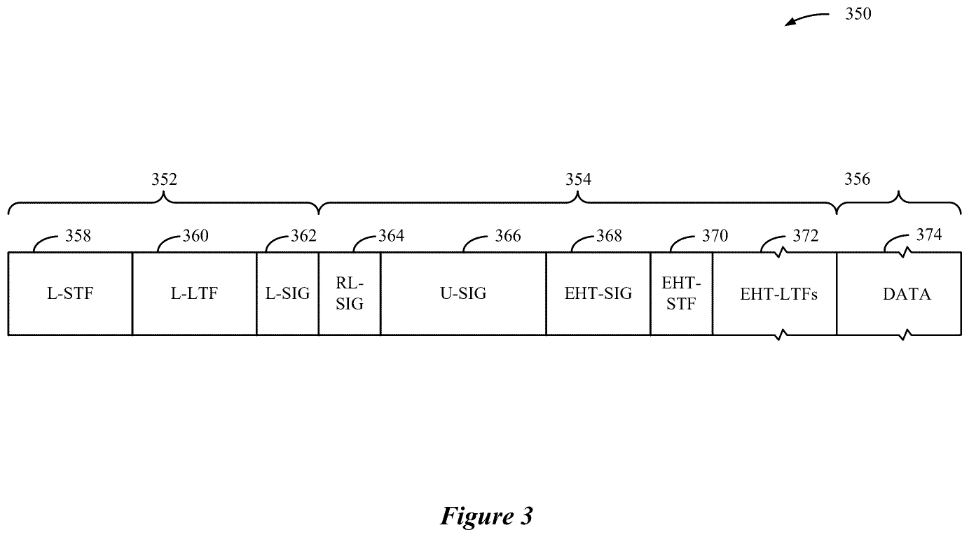

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as the AP 102 or the STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (for example, STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

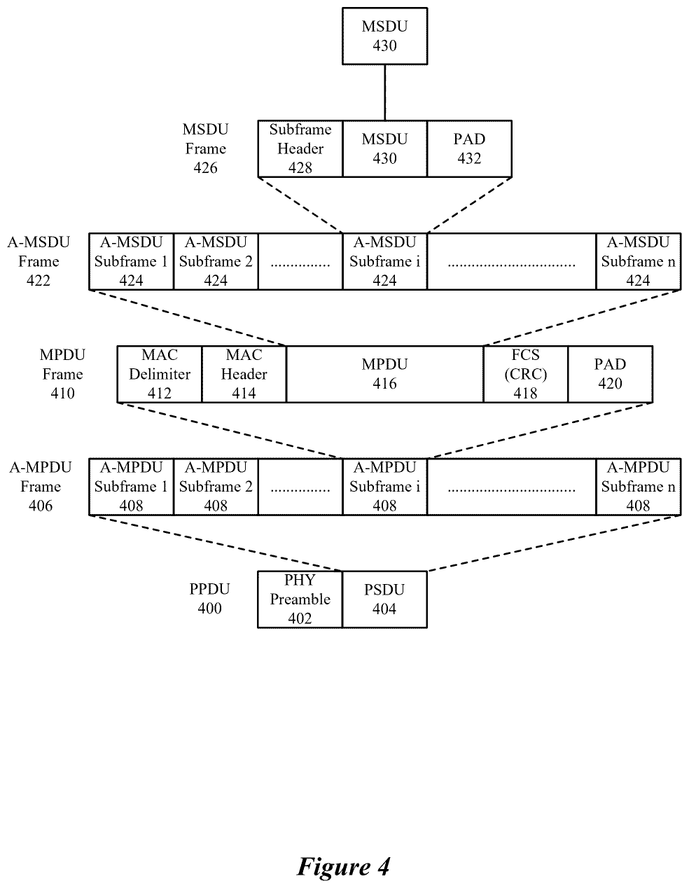

FIG. 4 shows a hierarchical format of an example PPDU usable for communications between a wireless AP 102 and one or more wireless STAs 104. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 406 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field may include a cyclic redundancy check (CRC)) and padding bits 420. The MPDU 416 may carry one or more MAC service data units (MSDUs) 422. For example, the MPDU 416 may carry an aggregated MSDU (A-MSDU) 422 including multiple A-MSDU subframes 424. Each A-MSDU subframe 424 contains a corresponding MSDU 430 preceded by a subframe header 428 and in some cases followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body 416. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 414 also includes one or more fields indicating addresses for the data encapsulated within the frame body 416. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

### Overview of Multi-Link Devices

A multi-link device (MLD) generally refers to a single device or equipment that includes two or more station (STA) instances or entities, implemented in a physical (PHY)/medium access control (MAC) layer and configured to communicate on separate wireless links. In some examples, each MLD may include a single higher layer entity, such as a MAC Service Access Point (SAP) that may assign MAC protocol data units (MPDUs) for transmission by the separate STA instances.

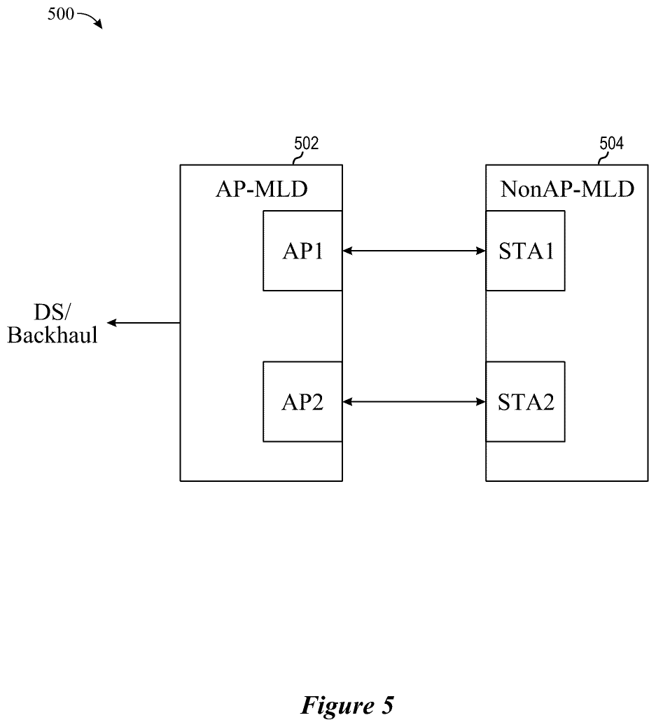

FIG. 5 depicts a block diagram of an example multi-link device (MLD) deployment.

As shown in FIG. 5, an access point (AP) MLD 502 may communicate with a non-AP MLD 504. Each of the AP MLD and non-AP MLD may include at least two STA entities 514 (hereinafter also referred to simply as “STAs”) that may communicate with associated STAs of another MLD. In an AP MLD, the STAs may be AP STAs 512 (STAs serving as APs or simply “APs”). In a non-AP MLD, the STAs may be non-AP STAs (STAs not serving as APs). As also described above, MLDs may utilize multi-link aggregation (MLA) (which includes packet level aggregation), whereby MPDUs from a same traffic ID (TID) may be sent via two or more wireless links.

Various modes of communication may be employed in MLD implementations. For example, a MLD may communicate in an Asynchronous (Async) mode or a Synchronous (Sync) mode. The Async mode provides flexibility to adapt to channel loading, allowing an MLD to perform channel access, transmit, and receive data via multiple links asynchronously. Sync mode may be preferred, however, if RF leakage exists between channels, because synchronized transmission on all links is unaffected by RF leakage.

In the Async mode, a STA/AP may count down (e.g., via a random backoff (RBO)) on both wireless links. A physical layer convergence protocol (PLCP) protocol data units (PPDU) start/end may happen independently on each of the wireless links. As a result, Async mode may potentially provide latency and aggregation gains. In certain cases, relatively complex (and costly) filters may be needed (for example, in the case of 5 GHz+6 GHz aggregation).

In the Sync mode, a STA/AP may also perform a backoff countdown on multiple wireless links as part of a channel access procedure. If a first link gains access to the medium through the channel access procedure, multiple links may transmit PPDUs at the same time. Accordingly, this mode may need some restrictions to minimize in-device interference.

The Sync mode may work in 5 GHz+6 GHz aggregation and may require relatively low-filter performance, while still providing latency and aggregation gains. However, due to that STA's tiled architecture, this latency and aggregation gains may be hard to achieve.

Although not shown, a third mode of communication may include a Basic (for example, multi-primary with single link transmission) mode. In the Basic mode, a STA/AP may also count down on both wireless links. However, transmission may only occur on the wireless link that gains access to the medium. The other wireless link may be blocked by in-device interference greater than −62 decibels per milliwatt (dBm). No aggregation gains may be realized in this mode.

In some cases, APs (e.g., non-collocated APs present at different physical locations) may be connected as affiliated APs of a single AP MLD. As a result, when a STA (e.g., of a non-AP MLD) transitions between these APs, the STA can bypass MLO (re) association and the 4-way handshake procedure. These techniques may be referred to as seamless roaming or make-before-break handover procedures, which may avoid data interruption and reduce delay during handover.

Seamless roaming may be considered a useful feature in ultra-high reliability (UHR) networks, enabling a client device to move from one serving AP to another without requiring reassociation. Seamless roaming may involve a UHR AP providing information related to a single mobility domain (SMD) entity (e.g., an SMD AP MLD), advertising candidate AP(s) for a client to select for roaming and possibly a transfer of context between APs. Such a handover may be initiated by a non-AP MLD (e.g., a STA), or the network may recommend to a non-AP MLD to move to a different set of (e.g., collocated or noncollocated) serving APs.

### Overview of Coordinated Communications

In downlink (DL) multi-user multiple-input-multiple-output (MU-MIMO), multiple stations may belong to one basic service set (BSS) transmitting in the DL. Other BSSs (OBSSs) within “hearing” range may defer (not transmit on the medium) in response to detecting an on-going transmission. Different BSSs in hearing range of each other may use time-divisional multiplexing (TDM) to transmit in the DL. In coordinated UL MU-MIMO, multiple BSSs carry out simultaneous UL transmissions. Un-used receive spatial dimensions at the AP may be used to null the interference from the other BSS (OBSS) transmissions. This enables a greater degree of spatial multiplexing when there are un-used spatial dimension within the BSS. In other words, the un-used spatial dimensions may allow for concurrent OBSS transmissions in DL.

Using coordinated DL MU-MIMO, the signal from each (coordinating) AP may be transmitted to only stations within their respective BSSs. While the data transmissions from the APs may cause interference to the other OBSS stations, un-used dimensions at the AP may be used to cancel (e.g., null out) interference from one or more OBSS APS.

In uplink (UL) multi-user multiple-input-multiple-output (MU-MIMO), multiple stations belonging to one BSS may transmit in the UL. Other BSSs within range may defer to an on-going transmission. Different BSSs in range of each other may use time-divisional multiplexing (TDM) to transmit in the UL. In coordinated UL MU-MIMO, multiple BSSs carry out simultaneous UL transmissions. As with DL MU-MIMO, un-used receive spatial dimensions at an AP may be used to null the interference from the other BSS (OBSS) transmissions, enabling a greater degree of spatial multiplexing and allowing for concurrent OBSS transmissions.

Using coordinated UL MU-MIMO, the signal from each STA may be transmitted to only one AP within their respective BSSs. While the data transmissions from the STAs may cause interference to the other OBSS APs, un-used spatial dimensions at each AP may be used to mitigate (e.g., reduce or null out) interference from OBSS STAs.

Coordinated beamforming (CoBF) may include one or more protocols for coordinating (e.g., synchronizing) transmissions from different entities, for example, to form nulls to control interference to STAs of other OBSS, while transmitting to (own BSS) STAs.

In CoBF, multiple APs may coordinate to suppress OBSS interference in the spatial domain. As such, CoBF typically provides gains in an opportunistic manner, for example, when in-BSS transmissions are not fully utilizing that BSS AP's spatial dimensions.

There are various types of CoBF, such as symmetric CoBF with synchronized and/or asynchronized transmission and asymmetric CoBF with synchronized and/or asynchronized transmission. With symmetric CoBF, all APs may participate in coordinated beamforming and may suppress their OBSS interference to other victim STAs within other BSSs. With asymmetric CoBF, one device (e.g., or a set of devices) may have higher or lower priority than other devices and/or may lack the capability to suppress OBSS interference.

In general, there can be multiple APs participating in MAPC schemes, such as CoBF. To facilitate understanding, however, example techniques will be described herein with reference to an MAPC scenarios involving 2 APs. The techniques described herein may be extended to systems involving any number of APs.

### Inter-Node Communication Framework for Coordinated Wireless Node Mechanisms

Aspects of the present disclosure provide techniques and mechanisms that may form a framework for inter-AP communications for MAPC sessions. These techniques and mechanisms may be applied to any coordination feature including (but not limited to) C-TDMA, C-SR, CLI, C-BF, and/or C-Preemption.

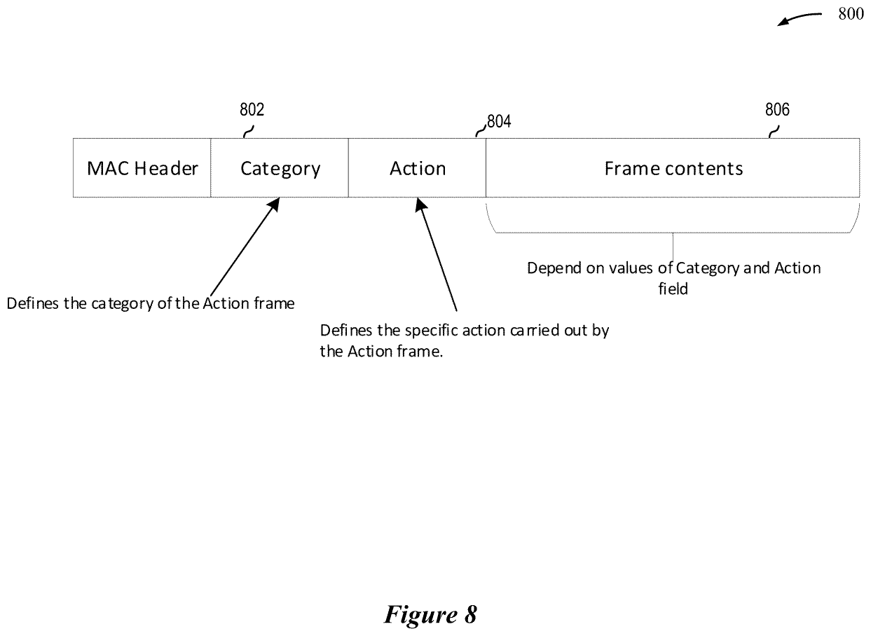

To enable the general CAP framework, aspects of the present disclosure propose various structures that may be used as containers for inter-AP communication. Such containers may be used to carry information to support the CAP protocols. Example details of such containers are described with reference to FIGS. 8-12.

Aspects of the present disclosure also propose various procedures (which may form the basis of protocols) for CAP information exchange, which may support advertisement of CAP information, discovery, information gathering/exchange, and setup of CAP sessions. The exchange of information may be used for enablement/negotiation of CAP features, updates to CAP parameters, and/or teardown of CAP sessions.

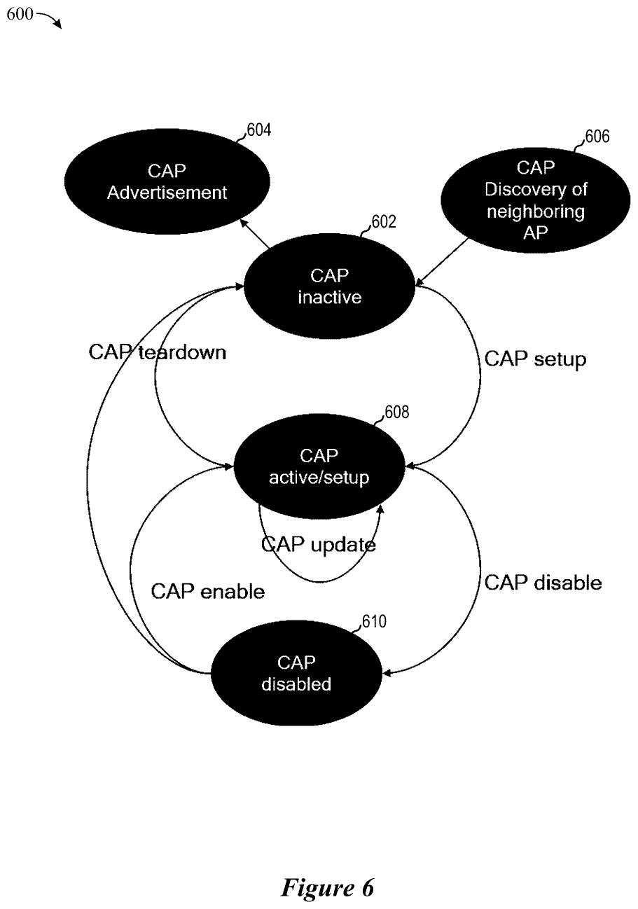

The exchange of information may be understood with reference to the example state diagram 600 of FIG. 6.

As indicated at 602, an AP may initially be in an MAPC inactive state (e.g., when the AP boots up). While in this state, the AP may not yet be able to participate in any CAP feature with neighboring APs. To participate with neighboring APs in CAP features, an AP must first perform CAP discovery.

If an AP intends to invite other neighboring APs to participate in CAP features, as indicated at 604, the AP may advertise its CAP information in Broadcast frames (e.g., Beacon, extended Beacon, Probe Response, or CAP Advertisement frames). As indicated at 606, an AP may discover its neighboring APs when it receives an MAPC advertisement information from those neighboring APs.

As indicated at 608, after discovery, an AP can perform an MAPC session setup (e.g., to activate an MAPC session). After setup, the CAP session may be updated, or an MAPC session may be disabled, as indicated at 610. A CAP session may be torn down, causing the AP to return to the CAP inactive state.

Aspects of the present disclosure provide various options for how an AP may enter or exit an MAPC disabled state. For example, from an MAPC active/enabled state, an AP may enter an MAPC disabled state after receiving a frame (e.g., with a frame or element) that indicates an AP should disable CAP operation. In some cases, an AP may transition from the CAP disabled state to the CPA inactive state (e.g., after a period of inactivity or signaling via a frame or element) or after a period for which the AP indicated it was willing to participate in an MAPC session (as described below). In some cases, an AP may transition from the CAP disabled state to an MAPC active/enabled state after receiving a frame (e.g., with a frame or element) that indicates an AP should re-activate/re-enable CAP operation.

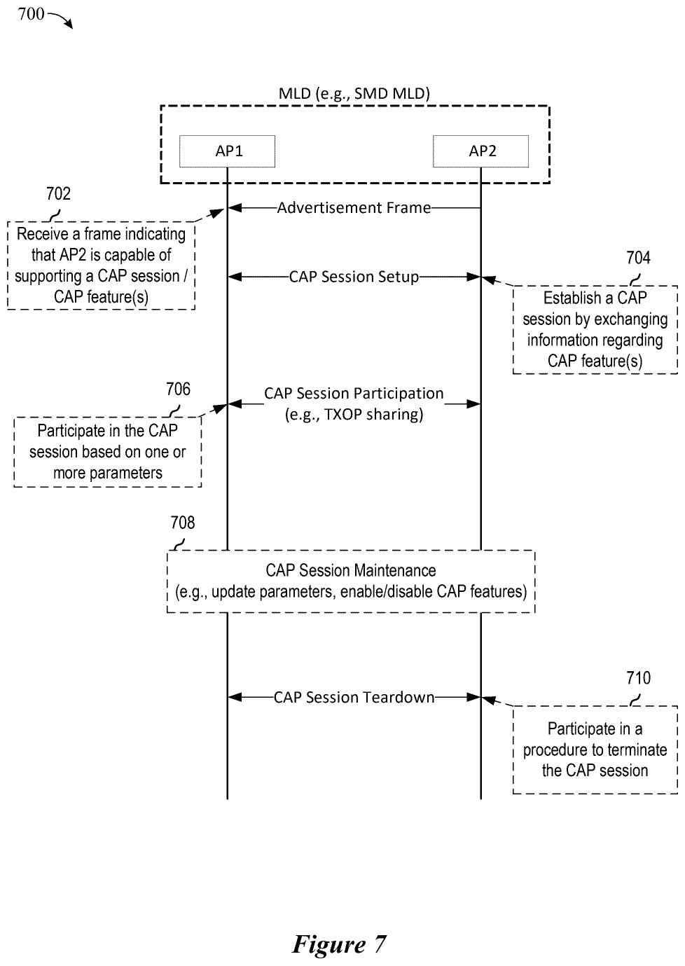

FIG. 7 illustrates an example call flow diagram 700 for establishing an MAPC session between two APs (AP1 and AP2), via information exchange in accordance with aspects of the present disclosure. In some case, AP1 and/or AP2 may be examples of an AP 102 shown in FIG. 1. In some cases, AP1 and AP2 may be part of an MLD, such as an SMD MLD. In some cases, AP1 and AP2 may be associated with different BSSs.

As indicated at 702, API obtains a frame (e.g., an Advertisement frame) indicating that AP2 is capable of supporting a coordinated communication scheme. As indicated at 704, AP1 and AP2 may establish a session by exchanging information regarding one or more features of the coordinated communication scheme supported by each other. In some cases, the exchanged information may include parameters which may be relevant (e.g., considered essential) for AP1 and AP2 to participate in an MAPC feature under the CAP session.

As indicated at 706, AP1 and AP2 may participate in the CAP session based on one or more parameters associated with the exchange of information (e.g., determined as part of the exchange of information). In some cases, as indicated at 708, CAP session maintenance may be performed, for example, with the update of one or more parameters and/or enabling/disabling one or more CAP features. As indicated at 710, AP1 and AP2 may participate in an MAPC Session teardown, which generally refers to a procedure to terminate the CAP session. After the teardown, each of AP1 and AP2 may return to an MAPC inactive state.

In some cases, CAP Advertisement may be performed by including an MAPC element in broadcast frames that an AP transmits. The broadcast frame (e.g., a Beacon, extended Beacon, Probe Response, or CAP Advertisement frame) carrying the CAP element may be transmitted periodically (such as every beacon interval or every 20 milliseconds) by every AP that intends to participate in CAP. In some cases, discovery of neighboring APs may be performed via backhaul.

In some cases, during CAP discovery/advertisement, an AP may proactively indicate how long it is willing/able to participate in an MAPC session. After that time, the AP may get out of an MAPC session without any further indication. In some cases, such signaling could be global (e.g., applying to all types of CAP operations the AP is participating in) or could be specific to each type of CAP operation. Depending on whether the signaling is global or type-specific, the signaling could be carried either in the common portion of CAP information element (IE) or in a per-CAP-type profile. Alternatively, the signaling could be carried in a separate field or element within a frame.

In some systems, the information carried in an MAPC element may be organized in a section or profile form, where each profile (or section) carries feature specific information. For example, if a transmitting device supports C-TDMA, C-SR, and CLI, the CAP element may have 3 profiles—one for each supported CAP feature (or behavior). The profile for C-TDMA may carry information specific to C-TDMA. There can be a common portion that carries information applicable to all the CAP behaviors supported by the transmitting device. In addition, there could be an encoding scheme defined by the standard that identifies each feature. For example, a 3-bit field carried at the beginning of a profile may identify the CAP feature that the profile represents. As an example, the value 000 could represent C-TDMA, value 001 could represent CLI, value 010 could represent C-SR, and so on.

In some cases, the information relevant for CAP session establishment may be carried in an element, such as an MAPC element. In some systems during discovery or CAP capability exchange, the CAP element may carry minimum content (e.g., a limited amount of information) necessary to enable CAP setup or other CAP actions, preventing information bloating (e.g., unnecessary information overhead). In some systems, the CAP element may carry full information during CAP setup or CAP negotiations. A CAP profile can include all elements and fields that are specific to the corresponding CAP feature.

In some systems, when full information is carried, inheritance may be applied across the profiles such that any information that applies to more than one type of CAP feature does not need to be duplicated. For example, if a C-TDMA profile carries most of the information that applies to other profiles, the C-TDMA profile may be carried as the first profile and subsequent profiles (such as profile containing information for C-SR) may inherit one or more elements or fields from the C-TDMA profile. The profile may also include an element that indicates non-inheritance (for example by inclusion of a Non-Inheritance element as the last element). If an element is not present in a particular CAP profile, and the element is not listed in the Non-Inheritance element (if included) in the profile for that CAP feature, then a device receiving the frame may consider that element to be part of that CAP profile, and the contents of the Information field of the element may apply to that CAP feature.

The general purpose of the CAP element may be to let neighboring APs know that the AP is interested in participating in CAP features with neighboring APs. Any further exchange with the neighboring APs may be done through unicast CAP Action frames during CAP session setup. In some aspects, the minimum information in the CAP element may include CAP capabilities in the CAP Common Info field (e.g., C-TDMA is supported, C-SR is not supported, C-BF is not supported, CLI is supported), a list of enabled CAP features, CAP capacity, and/or an MAPC status field. A per-CAP Info field is generally not to be included in the CAP element's minimum information.

An AP that receives a frame from a neighboring AP carrying the CAP element, thereby discovering the neighboring AP, may send unicast CAP Action frames to setup/negotiate/enable CAP features to that neighboring AP if it intends to establish an MAPC session with that neighboring AP.

When the AP discovers a neighboring AP that supports one or more CAP features (e.g., and that is willing to participate in CAP feature(s)), the AP can initiate an MAPC session setup with the neighboring AP. CAP session setup may establish a trusted relationship with the neighboring AP and may also include sharing of CAP-related (e.g., common and feature-specific) capabilities, and various parameters that may be required for the APs to participate in CAP features through the established CAP session.

CAP session setup may be commonly configured across all CAP features or individually configured for each CAP feature. In some aspects, the CAP setup may include a negotiation step, where each AP provides its preferred parameters for one or more CAP features, and the other AP accepts, rejects, or provides alternative parameters. The final parameter set used for the CAP scheme, if the setup is successful, will be the parameter set that both APs agree to.

In some aspects, CAP session setup with a neighboring AP may include exchange of CAP Request/Response frames (e.g., and/or other frames, such as notify/confirm frames).

In this setup process, the APs may exchange detailed CAP information. This information may include, for example, a set of CAP features requested for setup (e.g., C-TDMA and CLI), and parameters of CAP features requested for setup (e.g., for C-TDMA, the minimum and maximum shared TXOP duration that the AP is willing to share/receive). In some aspects, these CAP Request/Response frames may be exchanged via a secure channel. For example, CAP Request/Response frames may use AP PeerKey or Certificate based security (e.g., where the certificate is issued from a trusted 3rd party).

If negotiation is involved, one or more frames (e.g., request/response or notify/confirm) may be exchanged between APs. For example, once an MAPC Response frame is received with Status Code equal to (e.g., or indicating) SUCCESS, the CAP session is established between the initiating and responding AP. CAP setup needs to be performed only once for an AP pair, unless the CAP session is torn down, in which case CAP (re)setup may be performed (again) between the two APs.

According to certain aspects of the present disclosure, the scope of an MAPC session may vary. In some aspects, a single CAP session may extend to all CAP features. This may be advantageous in that APs will not need to perform CAP session setup on a per-CAP feature level, which might lead to more signaling overhead. Alternatively, in some aspects, an MAPC session may be maintained on a per-feature basis. For example, a first CAP session (CAP session 1) may be applicable to a first CAP feature (feature 1), while a second CAP session (CAP session 2) may be applicable to a second CAP feature (feature 2).

A CAP session is generally defined by an overarching agreement between two APs to participate and maintain the parameters of one or more CAP features (e.g., depending on the scope of the CAP session). Such an MAPC session may encompass multiple “sub-agreements” for coordination. For example, there may be multiple feature-specific sessions within an overarching CAP session (e.g., multiple TWT Service Periods for C-RTWT, each identified by a TWT ID).

In some aspects, between CAP discovery and CAP session setup, there may be an optional CAP information gathering phase (e.g., similar to probing features defined for AP-STA communications). CAP information gathering may be performed using the same frames as CAP session setup (e.g., CAP Request/Response or Notify/Confirm). A field in the frame (e.g., the Request code field) may indicate whether the frame is requesting information or setup. Alternatively, a different frame (such as an MAPC Information Request/Response frame) may be defined. The CAP information gathering phase may be used by the AP to determine whether the neighboring AP is suitable for performing CAP session setup, especially when the minimum information obtained during CAP discovery may be insufficient for such a determination.

In some aspects, when the initiating AP and receiving AP are affiliated with an MLD, the initiating AP may request to perform CAP session setup on two or more links. In this case, the CAP element may be included within a Multi-Link element. For example, the CAP element corresponding to Link ID j may be included in a per-STA profile with Link ID field set to j. This may provide certain benefits by allowing two APs to setup coordination across multiple links that both of them are operating on and/or allowing setup/updates/discovery over a single link. Even though CAP session setup/discovery/maintenance may be performed for multiple links over a single link, the scope of an MAPC session may be link-specific. That is, it may be required that a separate CAP session is established on each link before the APs may participate in one or more CAP features on the respective links.

This framework may also allow for cross-link CAP session setup. For example, a transmitting AP may include the Multi-Link Link Information element to indicate that the CAP Session setup requested in the CAP Request frame does not apply to the link on which the frame is transmitted, but to a different link that is indicated in the Link ID bitmap field of the Multi-Link Link Information element.

As noted above, after the initial CAP session setup, the AP may perform actions to maintain the CAP session. This may involve dynamically updating CAP parameters (e.g., which may be common parameters or per-CAP feature parameters), and/or enabling/disabling (e.g., temporarily pausing) one or more CAP features. CAP session maintenance may be based on traffic characteristics of an AP's BSS. For example, an AP may enable an MAPC feature if a non-AP STA starts sending or receiving latency-sensitive traffic to/from the AP and may disable the CAP feature otherwise.

In some cases, CAP session maintenance may involve exchange of CAP Notification frames to dynamically enable/disable CAP features. CAP Notification frames may be exchanged based on an individual AP's BSS requirements (e.g., presence of low-latency traffic).

In some aspects, two or more CAP Notification frames may be exchanged between each AP pair. For example, an initiating AP may send an MAPC Notification frame to enable a feature (e.g., enable C-TDMA with certain parameters). A responding AP may send an MAPC Notification frame to either accept the enablement, reject the enablement, or suggest an alternate enablement (e.g., enablement with alternate parameters). If the responding AP suggests an alternate enablement, the initiating AP may send another CAP Notification frame with different parameters, and the sequence may continue until enablement is ultimately successful or rejected.

To disable an MAPC feature, an AP may send an MAPC Notification frame with an enable flag set to 0. A responding AP may send an MAPC Notification frame when disablement is complete. In some aspects, a responding AP may not be allowed to reject a disablement.

When the APs are affiliated with an MLD, enablement/disablement may be performed for one link at a time or across multiple links, and the relevant information may be included in a Multi-Link element. In some aspects, the transmitting AP may include the Multi-Link Link Information element to indicate that the information indicated in the CAP frame does not apply to the link on which the frame is transmitted, but to a different link that is indicated in a Link ID bitmap field of the Multi-Link Link Information element.

In some aspects, updates to CAP parameters of an AP may be announced by that AP or other APs affiliated with that AP MLD in Broadcast management frames (e.g., Beacon/extended Beacon/Probe Response frame/CAP Advertisement frame). Such updates may leverage a critical update procedure for CAP parameters.

Updates to CAP parameters of an AP may also be sent to the neighboring APs in a unicast CAP Notification frame. A unicast CAP Notification frame may be suitable, for example, when the CAP parameters affect only a subset of the neighboring APs with which the affected AP has an MAPC session established. When an AP identifies that an MAPC parameter of a neighboring AP has been updated, the AP may send an MAPC Notification frame to make any updates (e.g., as applicable) to its CAP setup with the neighboring AP.

While an MAPC feature is enabled, the AP can participate in the CAP feature with its neighboring AP. For example, the AP may share a transmit opportunity (TXOP) with the neighboring AP as a sharing AP or receive a shared TXOP as a shared AP. As another example, an AP may end a TXOP before a CLI service period (SP) of another AP.

When an AP is no longer interested in participating in an MAPC feature with its neighboring AP with which it has an MAPC setup, the AP may perform an MAPC teardown procedure. CAP session setup is conceptually similar to “association” between APs and non-AP STAs. In baseline 802.11 standards, a non-AP STA needs to associate with the AP before it can “enable/disable” different modes. Similarly, in CAP, two APs may need to perform a “CAP session setup” to “enable/disable” CAP features (e.g., C-TDMA/C-SR, etc.).

When an AP has an established CAP session setup with a neighboring AP, and the AP no longer intends to participate in CAP features with that neighboring AP, the AP may initiate a teardown of the CAP session. In some aspects, the scope of CAP session teardown is the same as the scope of CAP session setup. In other words, if the CAP session is common across all CAP features, then the teardown may also be common across all CAP features. Similarly, if the CAP session is for a specific CAP feature, then the teardown may also be for a specific CAP feature.

According to certain aspects of the present disclosure, CAP teardown may be performed by transmitting an individually addressed CAP Request frame. In some aspects, a field in the frame (e.g., Request Code) may be set to a special value to indicate a teardown request (as opposed to requesting a session setup or information gathering). In some aspects, the neighboring AP that receives this frame may not be allowed to reject the request to tear down the CAP session. In some aspects, the neighboring AP may be required to transmit an MAPC Response with Status Code set to SUCCESS, indicating successful teardown. In some aspects, an MAPC session may be torn down automatically (such as without receiving the CAP Response frame) after the expiration of a timeout interval.

Alternatively, a separate CAP Teardown frame may be defined. For example, if the AP intends to teardown all established CAP sessions, the AP may transmit an individually addressed CAP Request (e.g., or Teardown) frame to all APs with which it has an established session. This may be advantageous, because each recipient AP may acknowledge/confirm receipt of the teardown request frame.

In some aspects, the AP may transmit a group addressed CAP Request (e.g., or Teardown) frame to a special feature-specific group address. In this case, individual recipient APs may not respond to the teardown request. However, the AP may transmit a Trigger frame (e.g., similar to a null data packet (NDP) Feedback Report Poll (NFRP)) to solicit a response (such as to acknowledge the receipt of the teardown request) from the recipient APs.

In some aspects, the AP may transmit a broadcast CAP Request (e.g., or Teardown) frame. In such cases, neighboring APs will not transmit a response frame to acknowledge the teardown request.

Implementing AP power save (PS) features provides many advantages for UHR. The two main variants of AP PS include static AP PS, which is based on a service period, and dynamic AP PS, which allows for “waking up” the AP on an as-needed basis. The “wake up” operation may be achieved with an Initial Control frame (ICF) which includes a padding field to enable the AP to transition from low power mode to normal mode.

If a first AP is in dynamic PS mode, another AP that intends to communicate with the first AP may precede its unicast CAP frames (e.g., along with any other frames sent to the first AP) with an ICF (e.g., MU-RTS Trigger frame). Group addressed frames may also be preceded with an ICF frame where there is a User Info field for each AP that is addressed by the group addressed frame. In some aspects, if a first AP is operating in the dynamic AP PS mode, another AP may be required to send a (e.g., individually or group addressed) frame to the first AP, even if it sends a Broadcast CAP frame to other neighboring APs.

If a first AP is in static PS mode, another AP that intends to communicate with the first AP may be required to transmit a frame to the first AP, only during the SPs when the first AP is in an active mode/awake state. During these active/awake periods, another AP may be allowed to send individually addressed, group addressed, or Broadcast CAP frames.

### Example Containers for Inter-AP Communication

Aspects of the present disclosure provide procedures/protocols for inter-AP information exchange, for the exchange of CAP session related parameters as described above. To enable the CAP framework disclosed herein, certain components are proposed that may be used as containers for inter-AP communication.

Such containers may carry information needed to support the CAP protocols, as well as procedures/protocols for the CAP information exchange (e.g., described above). Such procedures/protocols for CAP information exchange include advertisement of CAP information and discovery, information gathering, setup of CAP sessions, enablement/negotiation of CAP features, updates to CAP parameters, teardown of CAP sessions, and security considerations.

FIG. 8 shows an example of a frame format 800 that may be used to exchange CAP information. As illustrated, a category field 802 may define a category of the action frame, while an action field 804 may define a specific action carried out by the action frame.

Aspects of the present disclosure provide various options for frame formats for exchanging CAP information. For example, according to a first option, an existing frame format, such as a Public Action (or other type action) frame may be used. Using an existing frame format may be advantageous, for example, by leveraging existing infrastructure to define CAP communications. A Public Action frame may be used for inter-BSS communication (e.g., exchanged between two APs). According to a second option, a new management frame format (e.g., for an Action frame) specifically designed/intended for inter-BSS communication.

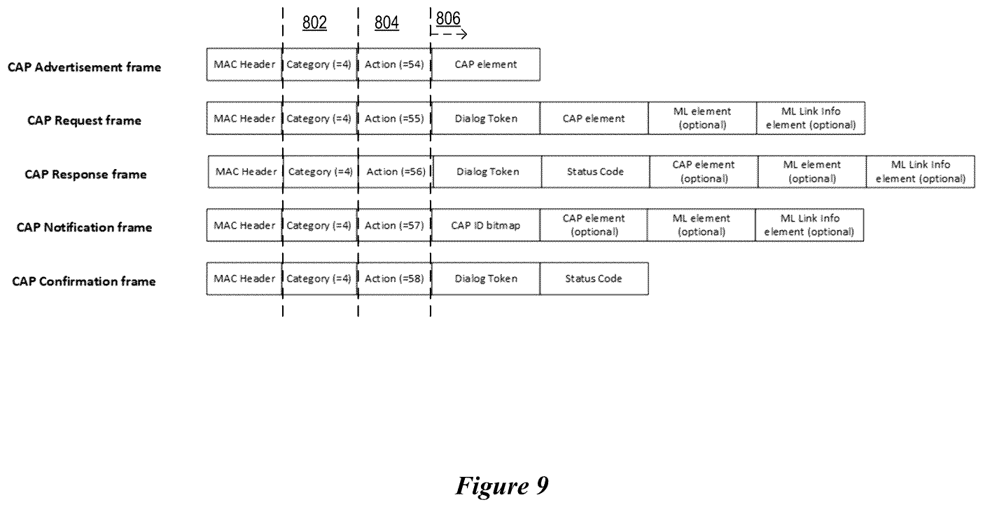

As illustrated in FIG. 9, according to the first option, new Public Action frame(s) may be defined by using one or more of the reserved/available values of the Public Action field 804. As illustrated, the Category field 802 of the various CAP Action frames may be set to a value (e.g., a value of 4) to indicate that the frame is a Public Action frame. The value of the Public Action field being set to a new value (such as a value that is currently reserved) may indicate that the Public Action frame is to be used for CAP communications.

In some aspects, more than one Public Action frame may be defined for different CAP tasks. For example, an MAPC Advertisement frame (e.g., which may be a management frame) may be defined for Advertisement/Discovery, an MAPC Request/Response frame may be defined for CAP session setup, information gathering or session teardown, an MAPC Notification frame may be defined for enablement/disablement/negotiation, and an MAPC Confirmation frame may be defined (e.g., for confirmation/acknowledgement).

As illustrated in FIG. 9, each new Public Action frame may be defined by a unique value of the Public Action field. As illustrated, values 54, 55, 56, 57, or 58 may indicate that the Public Action frame is an MAPC Advertisement frame, an MAPC Request frame, an MAPC Response frame, an MAPC Notification frame, or an MAPC Confirmation frame, respectively. The values and the order in which they represent the different CAP frames are illustrative examples only, however, wireless communications standards specifications may define different values and/or a different order.

As illustrated in FIG. 9, the frame (e.g., Public Action frame) contents 806 may carry one or more fields and/or elements. The number, order and the names of these fields/elements may depend on the value of the Public Action field. Such fields may include a Dialog Token field, a Request Code field, a Status code field, an enable/disable flag, an MAPC element, and/or a Multi-Link element. The enable/disable flag may be a bitmap where each bit corresponds to a specific CAP feature.

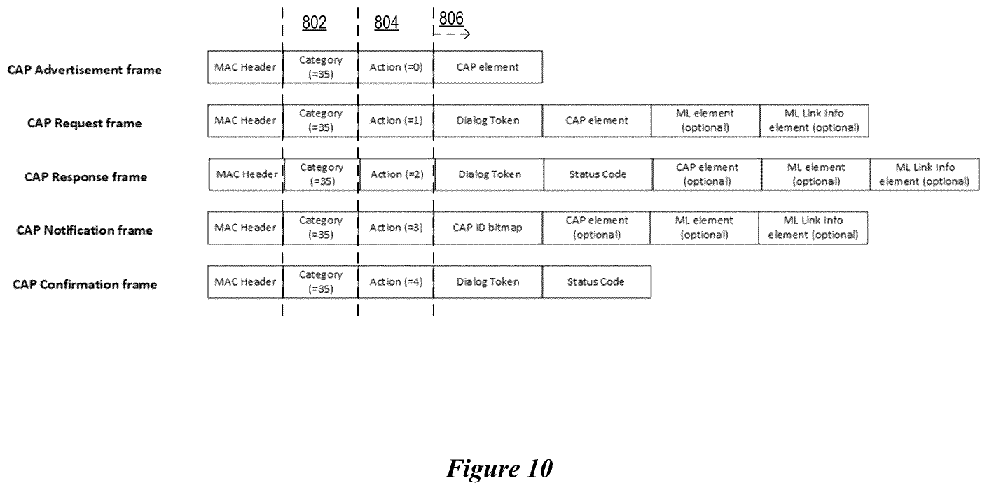

As illustrated in FIG. 10, according to the second option, one or more new CAP Action frame(s) may be defined by using one of the reserved values of a Category field 802. For example, a currently reserved value of the Category field (e.g., 35) may indicate that the frame is an MAPC Action frame. The Action field 804 may then be referred to as the CAP Action field. These CAP Action frame(s) may be used for inter-BSS communications.

In some aspects, more than one CAP Action frame may be defined for different CAP tasks. For example, an MAPC Advertisement frame may be defined for Advertisement/Discovery, an MAPC Request/Response frame may be defined for CAP session setup, information gathering, or session teardown, an MAPC Notification frame may be defined for enablement/disablement/negotiation, and/or an MAPC Confirmation frame may be defined (e.g., for confirmation/acknowledgement).

Each new CAP Action frame may be defined by a unique value of the CAP Action field. For example, a value of 0, 1, 2, 3, and 4 may indicate that the CAP Action frame is an MAPC Advertisement frame, an MAPC Request frame, an MAPC Response frame, an MAPC Notification frame, and an MAPC Confirmation frame, respectively. The values and the order in which they represent the different CAP frames are illustrative examples only, however, and wireless communications standards specifications may define different values and/or a different order.

As illustrated in FIG. 10, the frame contents 806 of the frame (e.g., CAP Action frame) may carry one or more fields and elements. The number, order and the names of these fields/elements may depend on the value of the CAP Action field. Such fields may include a Dialog Token field, a Request Code field, a Status code field, an enable/disable flag, an MAPC element and/or a Multi-Link element. The enable/disable flag may be a bitmap where each bit corresponds to a specific CAP feature.

Aspects of the present disclosure provide various techniques for addressing of CAP frames. In some aspects, for example, an MAPC Advertisement frame (e.g., which may be a management frame) may be sent with a Broadcast receiver address (RA). In some aspects, an MAPC advertisement frame may be transmitted to a group address or to an individual address (e.g., the RA of the receiving AP). In some aspects, CAP Request/Response, CAP Notification, and CAP Confirmation frames may be sent with an individually addressed RA (e.g., the RA of the receiving AP).

Certain aspects of the present disclosure may utilize group addressing schemes, and the AP may be allowed to set the RA field to these group addresses. In some aspects, feature specific group addresses may be utilized. For example, a first group address may be used for C-TDMA, and a second group address may be used for C-SR. Therefore, when an MAPC frame is sent to the C-TDMA group address, all the APs that participate in C-TDMA with the AP may receive and decode the frame. In some aspects, these group addresses may be defined in wireless communications standards, by the coordinating APs (e.g., serving as a local controller/coordinator), or by a central controller (e.g., the SMD MLD if these APs are affiliated with the SMD MLD).

In some aspects, the same set of frames may apply across all CAP features. In some cases, certain frames may be ‘common’ (e.g., applicable across all CAP features). In some aspects, feature-specific frames may be used for certain actions. For example, discovery/advertisement and notification may be associated with common CAP frames, while setup and teardowns may be feature specific (e.g., CLI Setup Request) frames.

In some aspects, a first AP (API) may support C-TDMA and C-SR features, while a second AP (AP2) may support C-TDMA only. In such cases, frames (e.g., including advertisement frames, negotiation frames, Request/Response frames, notification frames, confirmation frames, etc.) sent by API (e.g., within an MAPC session) may include information (e.g., capabilities and operational parameters) for C-TDMA and C-SR, whereas frames sent by AP2 (e.g., within the CAP session) may include information only for C-TDMA.

Aspects of the present disclosure provide an MAPC element (e.g., which may be included/carried in a frame) with a flexible design that allows the exchange of bare minimum information during discovery (e.g., to minimize bloating/excessive overhead), partial set of information during enablement/disablement, and complete information during setup.

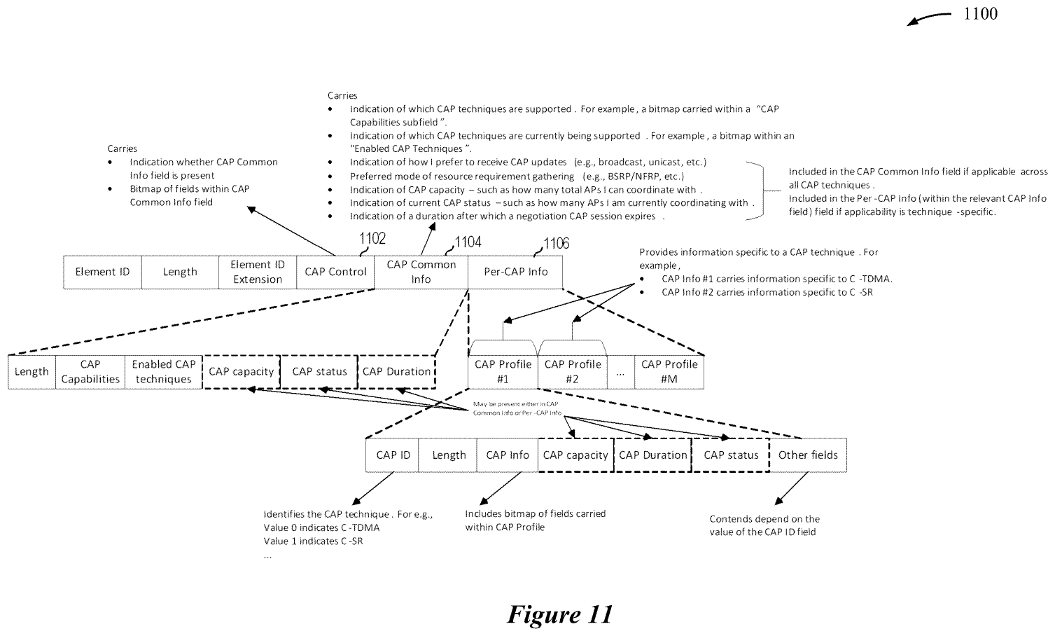

For example, FIG. 11 illustrates an example CAP element 1100 that may be used across discovery, setup, enablement, and updates. As illustrated, the CAP element 1100 may be flexible, allowing it to carry information for a specific CAP feature (e.g., only C-TDMA) or information for all CAP features. Further, the CAP element may be forward compatible, so that new CAP features that are defined in future generations can leverage the same element for signaling purposes.

In some aspects, the CAP Control field 1102 may include a bitmap representing which subfields are present in the CAP Common Information field 1104. A Per-CAP information field 1106 may include parameters associated with separate capabilities.

In some aspects, the CAP Common Information field 1104, the CAP Profile field, or both, may include a “Length” field for forward compatibility of the element. APs that receive the Length field in the Common Info field and CAP Profile field may decode the subfields of the Common Info/CAP Profile field that they can interpret and ignore the remaining portion(s) of the value carried in the Length field. For example, if the Length field indicates that the Length of the CAP Common Info field is 12 octets, but the receiving AP can only interpret the first 7 octets of the CAP Common Info field (because the remaining 5 octets are defined in a later generation/release), the receiving AP may decode the first 7 octets and ignore the remaining 5 octets of the CAP Common Info field. After ignoring the 5 octets, the receiving AP may infer that the Per-CAP Information field 1106 has started and may start processing the CAP Profile fields.

In some aspects, an MAPC Info field within the CAP Profile fields may provide a bitmap of presence indicators of the optional fields that are carried in the CAP Profile field. This bitmap may indicate to the receiver which fields are present, such that the receiver can correctly decode the CAP Profile fields.

In some aspects, CAP capacity may indicate a total quantity of APs that an AP is capable of coordinating with. In some aspects, CAP status may indicate how many APs an AP is currently coordinating with (e.g., which may indicate how many more APs the AP can coordinate with). The CAP capacity and CAP status fields may be “common” (e.g., across all CAP features) or may be feature-specific. If the CAP capacity and CAP status are common, then they may be carried in the CAP Common Info field. Otherwise, if the CAP capacity and CAP status are applicable at the CAP feature level, then they may be carried in the CAP Profile fields.

In some aspects, the CAP element may indicate a preference for receiving CAP updates (e.g., via broadcast, via unicast, etc.). The CAP element may also indicate a preferred mode of resource requirement gathering such as to understand how much resources are needed by the neighboring AP (e.g., BSRP/NFRP, etc.) and/or which features are currently enabled (e.g., via a bitmap). In some aspects, the CAP element may also indicate the duration after which a negotiated CAP session expires.

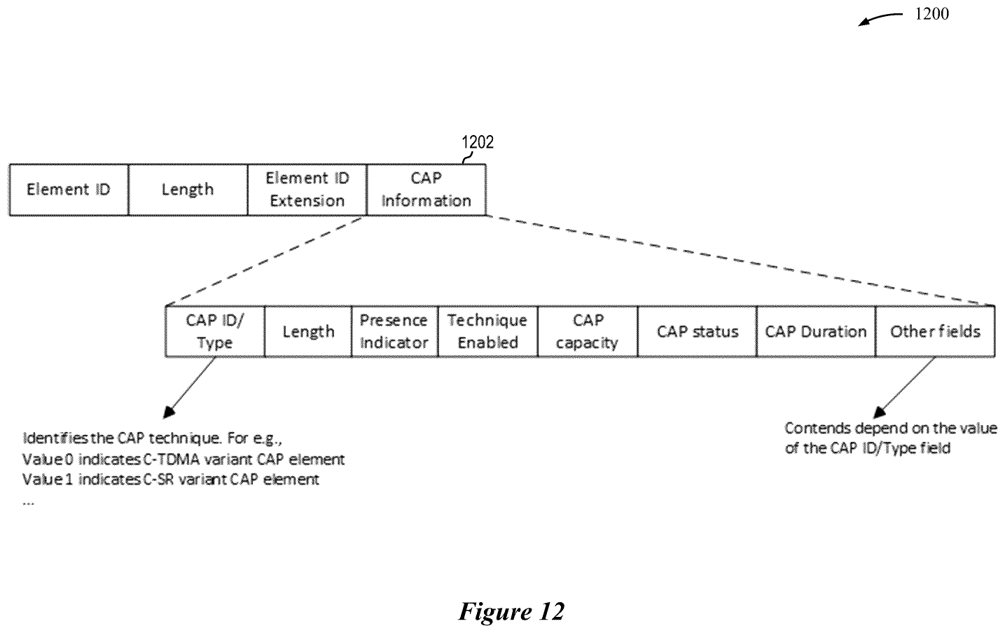

Certain variants (e.g., variant 2) of an MAPC element 1200 illustrated in FIG. 12 may be used as feature-specific CAP elements. As illustrated, CAP element 1200 may include an MAPC Information field 1202. As illustrated, the CAP Information field 1202 may include similar fields to the CAP Common Information field 1104 described above with reference to FIG. 11. In some cases, the CAP Information field 1202 may include different or other fields as well (e.g., in addition or instead).

In some cases, a hybrid option (e.g., between the variants shown in FIGS. 11 and 12) may be used. For example, certain variants of CAP elements may be defined with two information elements (IEs) defined with different Element ID Extension values. In such cases, feature-specific CAP elements (e.g., variant-2) may be included within a per-CAP Info field as a sub-element when the variant-1 CAP element is carried in a ‘CAP Common frame.’ In such cases, a feature-specific CAP element (e.g., variant-2) may be carried by itself when it is included in a feature specific frame (e.g., a CLI Setup Request frame).

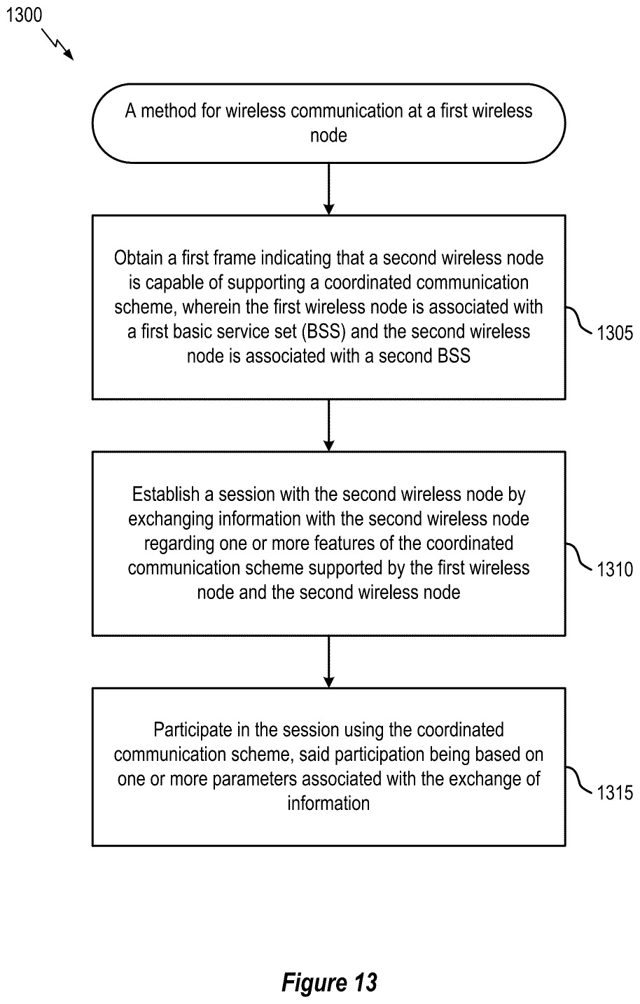

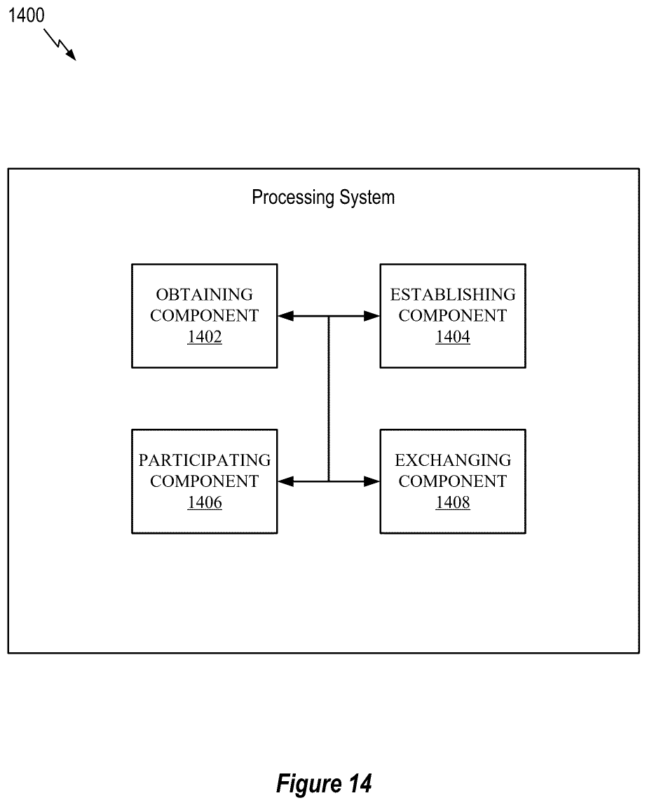

FIG. 13 shows an example of a process or method 1300 of wireless communication performable by or at a first wireless station. The operations of the process 1300 may be implemented by a wireless station or its components as described herein. For example, the process 1300 may be performed by a wireless communication device, such as the wireless communication device 1400 described with reference to FIG. 14, operating as or within a wireless station.

Method 1300 begins at step 1305 with obtaining a first frame indicating that a second wireless node is capable of supporting a coordinated communication scheme, wherein the first wireless node is associated with a first basic service set (BSS) and the second wireless node is associated with a second BSS. In some cases, the operations of this step refer to, or may be performed by, an obtaining component (e.g., circuitry for obtaining and/or code for obtaining) as described with reference to FIG. 14.

Method 1300 then proceeds to step 1310 with establishing a session with the second wireless node by exchanging information with the second wireless node regarding one or more features of the coordinated communication scheme supported by the first wireless node and the second wireless node. In some cases, the operations of this step refer to, or may be performed by, an establishing component (e.g., circuitry for establishing and/or code for establishing) as described with reference to FIG. 14.

Method 1300 then proceeds to step 1315 with participating in the session using the coordinated communication scheme, said participation being based on one or more parameters associated with the exchange of information. In some cases, the operations of this step refer to, or may be performed by, a participating component (e.g., circuitry for participating and/or code for participating) as described with reference to FIG. 14.

FIG. 14 shows a block diagram of a wireless communication device or wireless node 1400 (e.g., an AP, a non-AP STA, a non-AP MLD, a STA), according to some aspects of the present disclosure. For example, the wireless communication device 1400 may be configured or operable to perform one or more of the process 1300 described with reference to FIG. 13.

The wireless communication device 1400 may include one or more chips, SoCs, chipsets, packages, components or devices that individually or collectively constitute or comprise a processing system. The processing system may interface with other components of the wireless communication device 1400, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1400 may transmit the information output from the chip. In such an example, the second interface may refer to an interface between the processing system of the chip and a reception component, such that the device 1400 may receive information that is then passed to the processing system. In some such examples, the first interface also may obtain information, such as from the transmission component, and the second interface also may output information, such as to the reception component.

The processing system of the wireless communication device 1400 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1400 can be a device for use in an AP or an AP MLD, such as AP 102 described with reference to FIG. 1. In some other examples, the wireless communication device 1400 can be an AP that includes such a processing system and other components including multiple antennas. The wireless communication device 1400 is capable of transmitting and receiving wireless communications in the form of, for example, wireless packets. For example, the wireless communication device 1400 can be configurable or configured to transmit and receive packets in the form of physical layer PPDUs and MPDUs conforming to one or more of the IEEE 802.11 family of wireless communication protocol standards. In some other examples, the wireless communication device 1400 can be configurable or configured to transmit and receive signals and communications conforming to one or more 3GPP specifications including those for 5G NR or 6G. In some examples, the wireless communication device 1400 also includes or can be coupled with one or more application processors which may be further coupled with one or more other memories. In some examples, the wireless communication device 1400 further includes at least one external network interface coupled with the processing system that enables communication with a core network or backhaul network that enables the wireless communication device 1400 to gain access to external networks including the Internet.

In some examples, the wireless communication device 1400 can be a device for use in a STA or a non-AP STA, such as STA 104 described with reference to FIG. 1. In some examples, the wireless communication device 1400 further includes a user interface (UI) (such as a touchscreen or keypad) and a display, which may be integrated with the UI to form a touchscreen display. In some examples, the wireless communication device 1400 may further include one or more sensors such as, for example, one or more inertial sensors, accelerometers, temperature sensors, pressure sensors, or altitude sensors.

The wireless communication device 1400 includes obtaining component 1402, establishing component 1404, participating component 1406, and exchanging component 1408. Portions of one or more of the components 1402-1408 may be implemented at least in part in hardware or firmware. For example, the obtaining component 1402 and the establishing component 1404 may be implemented at least in part by a modem. In some examples, at least some of the components such as 1402, 1404, 1406, and/or 1408 are implemented at least in part by at least one processor and as software stored in a memory. For example, portions of one or more of the components 1402, 1404, 1406, and/or 1408 can be implemented as non-transitory instructions (or “code”) executable by the processor to perform the functions or operations of the respective module.

Various components of the wireless communication device 1400 may provide means for performing process 1300 described with reference to FIG. 13, or any aspect related thereto. Means for receiving or obtaining may include transceivers and/or antenna(s) of the AP 102 (or the STA 104) described with reference to FIG. 1 and/or the obtaining component 1402 of the wireless communication device 1400. Means for transmitting, sending or outputting (e.g., for transmission) may include transceivers and/or antenna(s) of the AP 102 (or the STA 104) described with reference to FIG. 1 and/or the outputting component 1404 of the wireless communication device 1400.

In some cases, rather than actually transmitting, for example, signals and/or data, the wireless communication device 1400 may have an interface to output or provide signals and/or data for transmission (means for outputting or means for providing). For example, a processor may output signals and/or data, via a bus interface, to a radio frequency (RF) front end of the wireless communication device 1400 for transmission. In various aspects, the RF front end may include various components, including transmit and receive processors, transmit and receive MIMO processors, modulators, demodulators, and the like.

In some cases, rather than actually receiving signals and/or data, the wireless communication device 1400 may have an interface to obtain the signals and/or data received from another device (means for obtaining). For example, a processor may obtain (or receive) the signals and/or data, via a bus interface, from an RF front end of the wireless communication device 1400 for reception. In various aspects, the RF front end may include various components, including transmit and receive processors, transmit and receive MIMO processors, modulators, demodulators, and the like. In various aspects, means for obtaining, means for establishing, means for outputting, and means for participating, means for exchanging, and/or means for using may comprise one or more processors (such as the one or more processors/components illustrated in the figures and/or described above).

### EXAMPLE CLAUSES

Implementation examples are described in the following numbered clauses.
Clause 1: A method for wireless communication at a first wireless node, comprising: obtaining a first frame indicating that a second wireless node is capable of supporting a coordinated communication scheme, wherein the first wireless node is associated with a first basic service set (BSS) and the second wireless node is associated with a second BSS; establishing a session with the second wireless node by exchanging information with the second wireless node regarding one or more features of the coordinated communication scheme supported by the first wireless node and the second wireless node; and participating in the session using the coordinated communication scheme, said participation being based on one or more parameters associated with the exchange of information.
Clause 2: The method of Clause 1, wherein the first frame is associated with a logical identifier that is associated with a group of wireless nodes.
Clause 3: The method of any one of Clauses 1-2, wherein the session is established with the second wireless node and at least a third wireless node.
Clause 4: The method of Clause 3, wherein the session is associated with a logical identifier.
Clause 5: The method of any one of Clauses 1-4, wherein the one or more features involve at least one of: coordinated time division multiple access (TDMA), coordinated spatial reuse (SR), coordinated restricted target wakeup time (C-RTWT), coordinated orthogonal frequency division multiple access (OFDMA), coordinated beamforming (BF), coordinated preemption, or other coordination technique.
Clause 6: The method of any one of Clauses 1-5, wherein: the first wireless node and the second wireless node are affiliated with a single mobility domain (SMD) multi-link device (MLD).
Clause 7: The method of any one of Clauses 1-6 wherein establishing the session comprises establishing coordination for medium access on a same channel on which the second wireless node establishes coordination for medium access.
Clause 8: The method of any one of Clauses 1-7, further comprising outputting a second frame indicating the first wireless node is capable of supporting the coordinated communication scheme, wherein the first frame is obtained after outputting the second frame.
Clause 9: The method of any one of Clauses 1-8, wherein the first frame comprises a management frame.
Clause 10: The method of any one of Clauses 1-9, wherein the exchange of information involves one or more action frames.
Clause 11: The method of any one of Clauses 1-10, wherein the first frame indicates at least one of: one or more features of the coordinated communication scheme supported by the second wireless node; or at least one of a status or a capacity of one or more features of the coordinated communication scheme.
Clause 12: The method of any one of Clauses 1-11, wherein the exchange of information involves at least one of: at least one request frame and at least one response frame; or at least one notify frame and at least one confirm frame.
Clause 13: The method of any one of Clauses 1-12, wherein the one or more parameters comprise at least one duration for which at least one of the first wireless node or the second wireless node is willing to participate in the coordinated communication scheme.
Clause 14: The method of any one of Clauses 1-13, wherein the one or more parameters comprise at least one of a minimum or maximum shared transmit opportunity duration.
Clause 15: The method of Clause 14, wherein the exchange of the at least one request frame and at least one involves/uses a security key.
Clause 16: The method of any one of Clauses 1-15, wherein the one or more parameters are applicable beyond a duration of the session.
Clause 17: The method of any one of Clauses 1-16, wherein the one or more parameters are only applicable for a duration of the session.
Clause 18: The method of any one of Clauses 1-17, further comprising exchanging additional information with the second wireless node to at least one of: dynamically enable one or more features of the coordinated communication scheme, or dynamically disable the one or more features of the coordinated communication scheme.
Clause 19: The method of Clause 18, wherein: the first wireless node and the second wireless node are multi-link devices (MLDs); and the exchange of additional information dynamically enables or dynamically disables the one or more features of the coordinated communication scheme for multiple links.
Clause 20: The method of any one of Clauses 1-19, further comprising: exchanging additional information to update the one or more parameters.
Clause 21: The method of any one of Clauses 1-20, further comprising participating in a procedure to terminate the session.
Clause 22: The method of Clause 21, wherein the procedure involves at least one of: at least one individually addressed request; at least one individually addressed request; or at least one group addressed request.
Clause 23: The method of any one of Clauses 1-22, wherein: at least one of the first wireless node or the second wireless node is in a power saving mode; and one or more frames involved in the session or the establishment of the session are, at least one of: preceded by a frame intended to wake up the at least one of the first wireless node or the second wireless node that is in a power saving mode, or output during a service period when the at least one of the first wireless node or the second wireless node that is in a power saving mode is in an active mode or awake state.
Clause 24: The method of any one of Clauses 1-23, wherein the exchange of information involves at least one action frame having a field set to a value to indicate one or more (e.g., public) action frames to be used for the exchange of information for the coordinated communication scheme.
Clause 25: The method of Clause 24, wherein the at least one action frame includes a plurality of profile sections, each profile section including information for a different feature of the coordinated communication scheme.
Clause 26: The method of Clause 25, wherein each profile section includes an identifier of a corresponding feature to which information in that profile section applies.
Clause 27: The method of Clause 25, wherein a first one of the profiles includes common information that is inherited by at least a second one of the profiles that lacks the common information, wherein the inheritance indicates that the common information applies to a feature of the coordinated communication scheme associated with the second profile.
Clause 28: The method of Clause 24, wherein: different types of (e.g., public) action frames are used to exchange information for different features of the coordinated communication scheme; and the field is set to a particular value to indicate one of the different types of (e.g., public) action frames.
Clause 29: The method of Clause 28, wherein at least one of a quantity, an order, a name of a field, or a name of an element in an action frame depends on the corresponding (e.g., public) action frame type.
Clause 30: The method of Clause 24, wherein at least one common type of the at least one action frame is used to exchange information for different features of the coordinated communication scheme.
Clause 31: The method of Clause 30, wherein the at least one common type is associated with at least one or more fields to convey information for the different features.
Clause 32: The method of Clause 24, wherein at least one of the at least one action frame or the one or more (e.g., public) action frames includes an information element (IE) used to exchange information for different features of the coordinated communication scheme.
Clause 33: The method of Clause 32, wherein the IE includes a bitmap representing which subfields are present.
Clause 34: The method of Clause 32, wherein the at least one action frame includes one or more indications of at least one of: a preference regarding receiving updates to parameters associated with the coordinated communication scheme; a preferred mode of resource information gathering; one or more features of the coordinated communication scheme that are currently enabled; or a duration after which the session expires.
Clause 35: An apparatus, comprising: at least one memory comprising executable instructions; and at least one processor configured to execute the executable instructions and cause the apparatus to perform a method in accordance with any combination of Clauses 1-34.
Clause 36: An apparatus, comprising means for performing a method in accordance with any combination of Clauses 1-34.
Clause 37: A non-transitory computer-readable medium comprising executable instructions that, when executed by at least one processor of an apparatus, cause the apparatus to perform a method in accordance with any combination of Clauses 1-34.
Clause 38: A computer program product embodied on a computer-readable storage medium comprising code for performing a method in accordance with any combination of Clauses 1-34.
Clause 39: A first wireless node (e.g., an access point) comprising: at least one transceiver; at least one memory comprising executable instructions; and at least one processor configured to execute the executable instructions and cause the apparatus to perform a method in accordance with any combination of Clauses 1-34, wherein the at least one transceiver is configured to receive the first frame.

### Additional Considerations

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by an AP STA may also (or instead) be performed by a non-AP STA. Similarly, operations performed by a non-AP STA may also (or instead) be performed by an AP STA.

Further, while the present disclosure may describe certain types of communications between different types of wireless nodes (e.g., between an AP STA and a non-AP STA), the same or similar types of communications may occur between same types of wireless nodes (e.g., between AP STAs or between non-AP STAs, in a peer-to-peer scenario). Further, communications may occur in reverse order than described.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable sub combination. As such, although features may be described above as acting in particular combinations, and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising:
at least one memory comprising computer-executable instructions; and
one or more processors configured to execute the computer-executable instructions to cause the apparatus to:
obtain a first frame indicating that a wireless node is capable of supporting a coordinated communication scheme, wherein the apparatus is associated with a first basic service set (BSS) and the wireless node is associated with a second BSS;
establish a session with the wireless node by exchanging information with the wireless node regarding one or more features of the coordinated communication scheme supported by the apparatus and the wireless node; and
participate in the session using the coordinated communication scheme, said participation being based on one or more parameters associated with the exchange of information.

2. The apparatus of claim 1, wherein the one or more features involve at least one of:
coordinated time division multiple access (TDMA), coordinated spatial reuse (SR), coordinated restricted target wakeup time (C-RTWT), coordinated orthogonal frequency division multiple access (OFDMA), coordinated beamforming (BF), coordinated preemption, or other coordination techniques.

3. The apparatus of claim 1, wherein the apparatus and the wireless node are affiliated with a single mobility domain (SMD) multi-link device (MLD).

4. The apparatus of claim 1, wherein the one or more processors are further configured to cause the apparatus to:
output a second frame indicating the apparatus is capable of supporting the coordinated communication scheme, wherein the first frame is obtained after outputting the second frame.

5. The apparatus of claim 1, wherein the exchange of information involves at least one of:
at least one request frame and at least one response frame; or
at least one notify frame and at least one confirm frame.

6. The apparatus of claim 5, wherein the exchange of the at least one request frame and at least one response frame involves or uses a security key.

7. The apparatus of claim 1, wherein the one or more processors are further configured to cause the apparatus to exchange additional information with the wireless node to at least one of:
dynamically enable one or more features of the coordinated communication scheme, or
dynamically disable the one or more features of the coordinated communication scheme.

8. The apparatus of claim 7, wherein:
the apparatus and the wireless node are multi-link devices (MLDs); and
the exchange of additional information dynamically enables or dynamically disables the one or more features of the coordinated communication scheme for multiple links.

9. The apparatus of claim 1, wherein the one or more processors are further configured to cause the apparatus to participate in a procedure to terminate the session.

10. The apparatus of claim 1, wherein:
at least one of the apparatus or the wireless node is in a power saving mode; and
one or more frames involved in the session or the establishment of the session are, at least one of:
preceded by a frame intended to wake up the at least one of the apparatus or the wireless node that is in a power saving mode, or
output during a service period when the at least one of the apparatus or the wireless node that is in a power saving mode is in an active mode or awake state.

11. The apparatus of claim 1, wherein the exchange of information involves at least one action frame having a field set to a value to indicate one or more action frames to be used for the exchange of information for the coordinated communication scheme.

12. The apparatus of claim 11, wherein the at least one action frame includes a plurality of profile sections, each profile section including information for a different feature of the coordinated communication scheme.

13. The apparatus of claim 11, wherein:
different types of action frames are used to exchange information for different features of the coordinated communication scheme; and
the field is set to a particular value to indicate one of the different types of action frames.

14. The apparatus of claim 13, wherein at least one of a quantity, an order, a name of a field, or a name of an element in an action frame depends on the corresponding action frame type.

15. The apparatus of claim 11, wherein at least one common type of the at least one action frame is used to exchange information for different features of the coordinated communication scheme.

16. The apparatus of claim 15, wherein the at least one common type is associated with at least one or more fields to convey information for the different features.

17. The apparatus of claim 11, wherein at least one of the at least one action frame or the one or more action frames includes an information element (IE) used to exchange information for different features of the coordinated communication scheme.

18. The apparatus of claim 17, wherein the IE includes a bitmap representing which subfields are present.

19. A first access point, comprising:
at least one transceiver;
at least one memory comprising computer-executable instructions; and
one or more processors configured to execute the computer-executable instructions and cause the first access point to:
receive, via the at least one transceiver, a first frame indicating that a second access point is capable of supporting a coordinated communication scheme, wherein the first access point is associated with a first basic service set (BSS) and the second access point is associated with a second BSS;
establish a session with the second access point by exchanging information with the second access point regarding one or more features of the coordinated communication scheme supported by the first access point and the second access point; and
participate in the session using the coordinated communication scheme, said participation being based on one or more parameters associated with the exchange of information.

20. A method for wireless communication at a first wireless node, comprising:
obtaining a first frame indicating that a second wireless node is capable of supporting a coordinated communication scheme, wherein the first wireless node is associated with a first basic service set (BSS) and the second wireless node is associated with a second BSS;
establishing a session with the second wireless node by exchanging information with the second wireless node regarding one or more features of the coordinated communication scheme supported by the first wireless node and the second wireless node; and
participating in the session using the coordinated communication scheme, said participation being based on one or more parameters associated with the exchange of information.
